(19) United States
(12) Patent Application Publication
(10) Pub. No.: US 2017/0332338 A1
(43) Pub. Date: Nov. 16, 2017

(54) SYNCHRONIZATION TECHNIQUES FOR MULTIPLE NODES IN A WIRELESS COMMUNICATIONS SYSTEM

(71) Applicant: QUALCOMM Incorporated, San Diego, CA (US)

(72) Inventors: Siddhartha Mallik, San Diego, CA (US); Anastasios Stamoulis, San Diego, CA (US); Aleksandar Damnjanovic, Del Mar, CA (US); Juan Montojo, San Diego, CA (US)

(21) Appl. No.: 15/487,359

(22) Filed: Apr. 13, 2017

Related U.S. Application Data
(60) Provisional application No. 62/334,073, filed on May 10, 2016.

(51) Int. Cl. H04W 56/00; H04W 74/08; H04W 48/10

(52) U.S. Cl. CPC H04W 56/001; H04W 48/10; H04W 74/0808

(57) ABSTRACT

Synchronization techniques for wireless nodes in a shared radio frequency spectrum band may include performing a listen before talk (LBT) procedure (e.g., a clear channel assessment (CCA) procedure) at identified resynchronization boundaries and initiating transmissions following successful LBT procedures. In the event that a node loses synchronization between resynchronization boundaries, such as due to an unsuccessful LBT procedure, the node becomes unsynchronized and may initiate an LBT procedure separate from the other nodes of the set of nodes. At a subsequent resynchronization boundary, the unsynchronized node may perform a resynchronization procedure in order to again become synchronized with other nodes of the set of nodes. In cases where the resynchronization procedure is unsuccessful, a parameter associated with the resynchronization procedure may be adapted to increase an interval for performing the resynchronization procedure.

### CROSS REFERENCES

The present Application for Patent claims priority to U.S. Provisional Patent Application No. 62/334,073 by Mallik, et al., entitled “Synchronization Techniques For Multiple Nodes in a Wireless Communications System,” filed May 10, 2016, assigned to the assignee hereof.

### BACKGROUND

The following relates generally to wireless communication, and more specifically to synchronization techniques for multiple wireless nodes in a shared radio frequency spectrum band.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

Some modes of communication may enable communication between a base station and a UE in a shared radio frequency spectrum band, or in different radio frequency spectrum bands (e.g., in a licensed radio frequency spectrum band and a shared radio frequency spectrum band) of a cellular network. However, in contrast to a carrier in a licensed radio frequency spectrum band, which may be allocated for use by the devices of one public land mobile network (PLMN) and be available to a base station or a UE of the PLMN at predetermined (or all) times, a carrier in a shared radio frequency spectrum band may be available for use by the devices of the PLMN intermittently. This intermittent availability may be a result of contention for access to the carrier of the shared radio frequency spectrum band, between devices of the PLMN, devices of one or more other PLMNs, and/or other devices (e.g., Wi-Fi devices). For some radio frames, a device of a PLMN may win contention for access to a carrier in the shared radio frequency spectrum band, while for other radio frames, the device may not win contention for access to the carrier in the shared radio frequency spectrum band.

In some contention-based systems, a base station or UE may perform a listen before talk (LBT) procedure to contend for access to the shared radio frequency spectrum band. An LBT procedure may include performing a clear channel assessment (CCA) procedure to determine whether a channel of the shared radio frequency spectrum band is available. When it is determined that the channel of the shared radio frequency spectrum band is available, a channel reservation signal (e.g., a channel usage beacon signal (CUBS)) may be transmitted to reserve the channel. When it is determined that the channel is not available, a CCA procedure may be performed for the channel again at a later time.

Because of the intermittent availability of carriers in a shared radio frequency spectrum band, base stations and UEs may use techniques that provide fairness in coexistence with other users of the shared radio frequency spectrum band, and that still provide reliable communications. For example, such techniques may include transmitting some information or types of radio frames using the dedicated radio frequency spectrum band and transmitting other information (e.g., lower priority information) or radio frames using the shared radio frequency spectrum band. Such techniques may be referred to as License-Assisted Access (LAA).

When different wireless nodes, such as base stations and UEs, of a same PLMN operator transmit over a shared radio frequency spectrum band, the different nodes may synchronize communications to provide that multiple nodes may concurrently transmit using the shared radio frequency spectrum band. In the event that a set of nodes is within an energy detection range of another node of a different PLMN operator or that may be using a different radio access technology (RAT), for example, a Wi-Fi node), the other node may cause a CCA procedure at one or more nodes in the set of nodes to fail and synchronization may be lost at such node(s).

### SUMMARY

The present disclosure, for example, relates to wireless communication systems, and more particularly to synchronization techniques for wireless nodes in a shared radio frequency spectrum band. In some examples, wireless transmissions using the shared radio frequency spectrum band may be synchronized, with each wireless node of a set of wireless nodes performing an LBT procedure (e.g., a CCA procedure) at identified resynchronization boundaries and initiating transmissions following successful LBT procedures. In the event that a node loses synchronization between resynchronization boundaries, such as due to an unsuccessful LBT procedure, the node becomes unsynchronized and may initiate an LBT procedure separate from the other nodes of the set of nodes. At a subsequent resynchronization boundary, the unsynchronized node may perform a resynchronization procedure in order to again become synchronized with other nodes of the set of nodes.

In some cases, the resynchronization procedure may be successful and the unsynchronized node may again become synchronized with the set of nodes. In other cases, the resynchronization procedure may be unsuccessful and the unsynchronized node may continue to gain channel access in an unsynchronized manner with the other nodes of the set of nodes. In some examples, a parameter associated with the resynchronization procedure may be adapted based at least in part on the outcome of the resynchronization procedure. In some examples, an interval for performing the resynchronization procedure may be increased in the event of an unsuccessful resynchronization procedure, and the unsynchronized node may skip a resynchronization procedure at a subsequent resynchronization boundary. In the event of a successful resynchronization procedure, some examples may provide that the interval for performing the resynchronization procedure may be reset to an initial value.

A method of wireless communications is described. The method may include synchronizing transmissions with one or more wireless nodes, identifying a loss of synchronization with the one or more wireless nodes, performing a resynchronization procedure at a first resynchronization boundary to attempt to resynchronize with the one or more wireless nodes, and adapting a parameter associated with the resynchronization procedure based at least in part on an outcome of the resynchronization procedure at the first resynchronization boundary.

An apparatus for wireless communications is described. The apparatus may include means for synchronizing transmissions with one or more wireless nodes, means for identifying a loss of synchronization with the one or more wireless nodes, means for performing a resynchronization procedure at a first resynchronization boundary to attempt to resynchronize with the one or more wireless nodes, and means for adapting a parameter associated with the resynchronization procedure based at least in part on an outcome of the resynchronization procedure at the first resynchronization boundary.

A further apparatus for wireless communications is described. The apparatus may include a processor, memory in electronic communication with the processor, and instructions stored in the memory. The instructions may be operable to cause the processor to synchronize transmissions with one or more wireless nodes, identify a loss of synchronization with the one or more wireless nodes, perform a resynchronization procedure at a first resynchronization boundary to attempt to resynchronize with the one or more wireless nodes, and adapt a parameter associated with the resynchronization procedure based at least in part on an outcome of the resynchronization procedure at the first resynchronization boundary.

A non-transitory computer readable medium for wireless communications is described. The non-transitory computer-readable medium may include instructions operable to cause a processor to synchronize transmissions with one or more wireless nodes, identify a loss of synchronization with the one or more wireless nodes, perform a resynchronization procedure at a first resynchronization boundary to attempt to resynchronize with the one or more wireless nodes, and adapt a parameter associated with the resynchronization procedure based at least in part on an outcome of the resynchronization procedure at the first resynchronization boundary.

In some examples of the method, apparatus, or non-transitory computer-readable medium described above, the adapting the parameter associated with the resynchronization procedure comprises: modifying an interval cycle for performing the resynchronization procedure.

In some examples of the method, apparatus, or non-transitory computer-readable medium described above, the adapting the parameter associated with the resynchronization procedure further comprises: determining that the resynchronization procedure at the first resynchronization boundary was successful, and increasing a probability that the resynchronization procedure will be performed at a second resynchronization boundary.

In some examples of the method, apparatus, or non-transitory computer-readable medium described above, the adapting the parameter associated with the resynchronization procedure further comprises: determining that the resynchronization procedure at the first resynchronization boundary was unsuccessful, and reducing a probability that the resynchronization procedure will be performed at a second resynchronization boundary.

In some examples of the method, apparatus, or non-transitory computer-readable medium described above, the adapting the parameter associated with the resynchronization procedure further comprises: determining that the resynchronization procedure at a predetermined number of resynchronization boundaries was unsuccessful, and disabling the resynchronization procedure.

Some examples of the method, apparatus, or non-transitory computer-readable medium described above may further include processes, features, means, or instructions for determining to perform or to skip the resynchronization procedure at a second resynchronization boundary based as least in part on interval cycle for performing the resynchronization procedure. Some examples of the method, apparatus, or non-transitory computer-readable medium described above may further include processes, features, means, or instructions for determining to skip the resynchronization procedure at a second resynchronization boundary based as least in part on the parameter associated with the resynchronization procedure.

Some examples of the method, apparatus, or non-transitory computer-readable medium described above may further include processes, features, means, or instructions for transmitting a wireless transmission that spans through the second resynchronization boundary. In some examples of the method, apparatus, or non-transitory computer-readable medium described above, transmitting the wireless transmission comprises: including one or more of an identifier or a stop time of the wireless transmission.

Some examples of the method, apparatus, or non-transitory computer-readable medium described above may further include processes, features, means, or instructions for determining to perform the resynchronization procedure at a second resynchronization boundary based at least in part on the parameter associated with the resynchronization procedure. Some examples of the method, apparatus, or non-transitory computer-readable medium described above may further include processes, features, means, or instructions for performing an LBT procedure as part of the resynchronization procedure at the second resynchronization boundary.

Some examples of the method, apparatus, or non-transitory computer-readable medium described above may further include processes, features, means, or instructions for identifying, during the LBT procedure, a wireless transmission of one of the one or more wireless nodes that spans the second resynchronization boundary. Some examples of the method, apparatus, or non-transitory computer-readable medium described above may further include processes, features, means, or instructions for maintaining the parameter associated with the resynchronization procedure based at least in part on the identification of the wireless transmission of one of the one or more wireless nodes. Some examples of the method, apparatus, or non-transitory computer-readable medium described above may further include processes, features, means, or instructions for initiating a synchronized wireless transmission at the second resynchronization boundary based at least in part on the identification of the wireless transmission of one of the one or more wireless nodes.

Some examples of the method, apparatus, or non-transitory computer-readable medium described above may further include processes, features, means, or instructions for determining to perform the resynchronization procedure at a second resynchronization boundary based at least in part on the parameter associated with the resynchronization procedure. Some examples of the method, apparatus, or non-transitory computer-readable medium described above may further include processes, features, means, or instructions for performing an LBT procedure as part of the resynchronization procedure at the second resynchronization boundary. Some examples of the method, apparatus, or non-transitory computer-readable medium described above may further include processes, features, means, or instructions for identifying, during the LBT procedure, a beacon signal from a different wireless node operating using a different RAT. Some examples of the method, apparatus, or non-transitory computer-readable medium described above may further include processes, features, means, or instructions for maintaining the parameter associated with the resynchronization procedure based at least in part on the identification of the beacon signal.

In some examples of the method, apparatus, or non-transitory computer-readable medium described above, the one or more wireless nodes are associated with a group of wireless nodes, and wherein the method further comprises: determining, at a first wireless node of the group of wireless nodes, that a second wireless node outside of the group of wireless nodes is operating using a first wireless channel. Some examples of the method, apparatus, or non-transitory computer-readable medium described above may further include processes, features, means, or instructions for transmitting, at the first wireless node, wireless transmissions that are unsynchronized with other wireless nodes of the group of wireless nodes using a second wireless channel. Some examples of the method, apparatus, or non-transitory computer-readable medium described above may further include processes, features, means, or instructions for transmitting, at other wireless nodes of the group of wireless nodes that are outside of an energy detection range of the second wireless node, synchronized wireless transmissions using the first wireless channel.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communication system, in accordance with various aspects of the present disclosure;

FIG. 2 illustrates an example of a wireless communications system that supports synchronization across transmitting nodes using shared radio frequency spectrum in accordance with aspects of the present disclosure;

FIG. 3 illustrates an example of a resynchronization procedure of synchronized transmitting nodes using shared radio frequency spectrum in accordance with aspects of the present disclosure;

FIG. 4 illustrates examples of successful and unsuccessful resynchronization procedure of synchronized transmitting nodes using shared radio frequency spectrum in accordance with aspects of the present disclosure;

FIG. 5 illustrates an example of a wireless transmission that transmits through a resynchronization boundary in accordance with aspects of the present disclosure;

FIG. 6 illustrates an example of wireless nodes operating using different wireless channels when within energy detection range of a different wireless node in accordance with aspects of the present disclosure;

FIG. 7 illustrates an example of a process flow in a system that supports synchronization across transmitting nodes using shared radio frequency spectrum in accordance with aspects of the present disclosure;

FIGS. 8 through 10 show block diagrams of a wireless device that supports synchronization for multiple nodes in accordance with aspects of the present disclosure;

FIG. 11 illustrates a block diagram of a system including a wireless device that supports synchronization for multiple nodes in accordance with aspects of the present disclosure; and

FIGS. 12 through 14 illustrate methods for synchronization for multiple nodes in accordance with aspects of the present disclosure.

### DETAILED DESCRIPTION

The present disclosure provides techniques for synchronization across transmitting nodes using a shared radio frequency spectrum band, which may enable enhanced utilization of wireless resources and thereby enhance network efficiency. In some deployments, when different wireless nodes (e.g., a base station or a UE) of a same PLMN operator transmit or receive over a shared radio frequency spectrum band in parallel, the nodes may operate in a reuse one mode when their LBT radio frame timings are synchronized and each transmitting node wins contention for access to the shared radio frequency spectrum band. In such deployments, when the LBT radio frame timings of the nodes are not synchronized, frequency reuse may not be used and unsynchronized nodes may contend for channel access separately from other nodes of the same PLMN operator. In such situations, any unsynchronized nodes may attempt to resynchronize at established resynchronization, or superframe, boundaries.

Resynchronization may be accomplished through a resynchronization procedure in which a node will discontinue or truncate a transmission a certain time period before the resynchronization boundary and perform an LBT procedure at the resynchronization boundary that is synchronized with other nodes of the PLMN operator. If the resynchronization is successful, the unsynchronized node is again synchronized with the other nodes, and reuse one mode operation may be continued. If the resynchronization is unsuccessful, the unsynchronized node then has to contend for channel access and continue to operate in an unsynchronized manner until a subsequent resynchronization boundary. In such cases, the unsynchronized node may have relinquished the shared radio frequency spectrum band earlier than it would have otherwise, which may reduce overall network efficiency.

In some examples, a node that has an unsuccessful resynchronization attempt may modify a parameter of the resynchronization procedure. Such a parameter may be a time interval for a next resynchronization attempt, which may be modified to allow the unsynchronized node to skip a subsequent resynchronization procedure at a next resynchronization boundary. In some examples, the parameter may be probability assigned to a determination of whether to perform the resynchronization procedure at a next resynchronization boundary or not. Such a probability may be decreased after an initial resynchronization failure, and may be further decreased after additional resynchronization failures. In some examples, the parameter may be reset to an initial value, such as a probability of 1.0, upon a successful resynchronization. In certain examples, if a node transmits through a resynchronization boundary, an identifier may be included with the transmission to indicate to other nodes of the PLMN operator that the transmitting node is a node of the PLMN operator and that the transmitting node is transmitting through the resynchronization boundary, and the end time of the current transmission. Another node of the PLMN operator, upon detecting the transmission and identification of the unsynchronized node, may maintain its parameter for the resynchronization procedure. In some examples, another node of the PLMN operator, upon detecting the transmission and identification of the unsynchronized node, may begin synchronized transmissions as though its LBT procedure has been successful.

Using such techniques may allow a node that operates using shared radio frequency spectrum to modify its resynchronization procedure to reduce the probability that the node will truncate a transmission in the event of multiple resynchronization failures. In such situations, the shared radio frequency spectrum may be somewhat crowded with other transmitters, with a reduced likelihood of synchronized transmissions among nodes of a PLMN operator. Thus, skipping one or more resynchronization boundaries may allow nodes to transmit with a reduced number of truncated transmissions due to resynchronization boundaries and thereby enhance overall throughput. Such nodes may continue to attempt resynchronization based on the modified timing interval or probability associated with a resynchronization procedure, allowing the nodes of the PLMN to become resynchronized at a point when fewer other nodes are transmitting.

In some examples, the shared radio frequency spectrum band may be used for a Long Term Evolution (LTE)/LTE-Advanced (LTE-A) communications and may be shared with devices that operate according to different RATs, such as Wi-Fi devices that operate according to IEEE 802.11 standards, for example. The shared radio frequency spectrum band may be used in combination with, or independent from, a licensed radio frequency spectrum band. The licensed radio frequency spectrum band may include a radio frequency spectrum band for which transmitting apparatuses may not contend for access (e.g., a radio frequency spectrum band licensed to particular users for particular uses, such as a licensed radio frequency spectrum band usable for LTE/LTE-A communications). The shared radio frequency spectrum band may include a radio frequency spectrum band for which transmitting apparatuses may contend for access using LBT procedures (e.g., a radio frequency spectrum band that is available for unlicensed use, such as Wi-Fi use, a radio frequency spectrum band that is available for use by different RATs, or a radio frequency spectrum band that is available for use by multiple operators in an equally shared or prioritized manner).

Aspects of the disclosure are initially described in the context of a wireless communication system that uses a shared radio frequency spectrum band and synchronization procedures for accessing the shared radio frequency spectrum band. Aspects of the disclosure are further illustrated by and described with reference to apparatus diagrams, system diagrams, and flowcharts that relate to synchronization techniques for wireless transmissions of multiple wireless nodes using a shared radio frequency spectrum band.

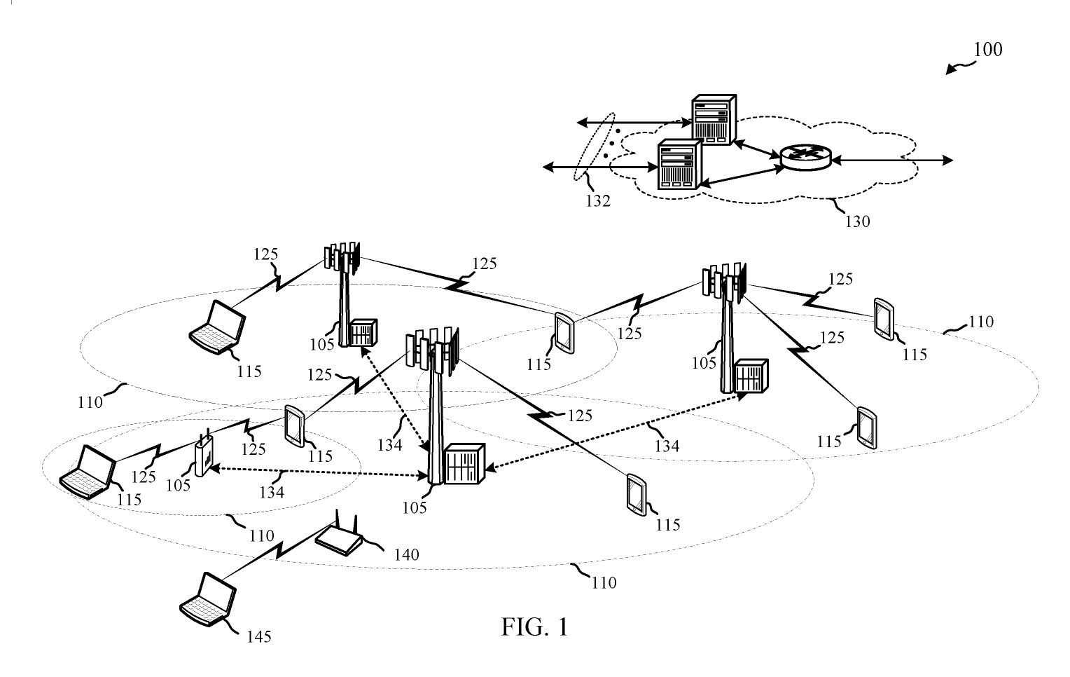

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE/LTE—A network that operates, at least in part, using a shared radio frequency spectrum band. Base stations 105 and UEs 115 may use synchronization techniques as discussed herein to provide adapted resynchronization parameters based on an outcome of a resynchronization procedure for transmissions in the shared frequency spectrum band, and thereby provide enhanced utilization of the shared frequency spectrum band.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device, etc.

In some examples, base stations 105 and UEs 115 may be associated with a first operator, such as a PLMN operator. As illustrated in FIG. 1, some examples may also have a second operator transmitting node such as first Wi-Fi node 140 (e.g., a Wi-Fi access point) and a second operator receiving node such as a receiving Wi-Fi node 145 (e.g., a Wi-Fi station) that may operate within a coverage area 110. The first Wi-Fi node 140 and receiving Wi-Fi node 145 may be, for example, Wi-Fi nodes that operate using at least a portion of the shared radio frequency spectrum band. In some examples, other nodes that use the shared radio frequency spectrum band may be LTE/LTE-A nodes of a different PLMN operator, instead of, or in addition to, other Wi-Fi nodes. Thus, the first Wi-Fi node 140 and receiving Wi-Fi node 145 may compete for access to one or more channels of the shared radio frequency spectrum band with base stations 105 and UEs 115.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

In some cases, a UE 115 or base station 105 may operate in a shared or unlicensed frequency spectrum. These devices may perform a LBT procedure such as a CCA prior to communicating in order to determine whether the channel is available. A CCA may include an energy detection procedure to determine whether there are any other active transmissions. For example, the device may infer that a change in a received signal strength indication (RSSI) of a power meter indicates that a channel is occupied. Specifically, signal power is that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

A base station 105 may gather channel condition information from a UE 115 in order to efficiently configure and schedule the channel. This information may be sent from the UE 115 in the form of a channel state report. A channel state report may contain an rank indicator (RI) requesting a number of layers to be used for DL transmissions (e.g., based on the antenna ports of the UE 115), a precoding matrix indicator (PMI) indicating a preference for which precoder matrix should be used (based on the number of layers), and a channel quality indicator (CQI) representing the highest modulation and coding scheme (MCS) that may be used.

A CQI may be calculated by a UE 115 after receiving predetermined pilot symbols such as cell-specific reference signals (CRS) or CSI-RS. RI and PMI may be excluded if the UE 115 does not support spatial multiplexing (or is not in support spatial mode). The types of information included in the report determine a reporting type. Channel state reports may be periodic or aperiodic. That is, a base station 105 may configure a UE 115 to send periodic reports at regular intervals, and may also request additional reports as needed. Aperiodic reports may include wideband reports indicating the channel quality across an entire cell bandwidth, UE selected reports indicating a subset of the preferred subbands, or configured reports in which the subbands reported are selected by the base station 105.

In some cases, wireless communications system 100 may utilize one or more enhanced component carriers (eCCs). An eCC may be characterized by one or more features including: flexible bandwidth, different transmission time intervals (TTIs), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum). An eCC characterized by flexible bandwidth may include one or more segments that may be utilized by UEs 115 that do are not capable of monitoring the whole bandwidth or prefer to use a limited bandwidth (e.g., to conserve power).

In some cases, an eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may support transmissions using different TTI lengths. For example, some CCs may use uniform 1 ms TTIs, whereas an eCC may use a TTI length of a single symbol, a pair of symbols, or a slot. In some cases, a shorter symbol duration may also be associated with increased subcarrier spacing. In conjunction with the reduced TTI length, an eCC may utilize dynamic time division duplex (TDD) operation (i.e., an eCC may switch from DL to UL operation for short bursts according to dynamic conditions).

As indicated above, in some examples UEs 115 and base stations 105 may employ frequency reuse based on synchronized LBT radio frames transmitted between UEs 115 and base stations 105. Thus, synchronized base stations 105 and UEs 115 may concurrently transmit on a same transmission frequency. Such concurrent transmissions may result in interference between the concurrent transmissions, and transmission rates of the concurrent transmissions may be selected to provide receivers of the transmissions with enhanced likelihood of successfully receiving their respective transmissions. For example, a transmitting base station 105 may use a MCS that is selected based on interference levels of one or more other concurrently transmitting base stations 105 at an intended receiving UE 115. In some examples, as will be discussed in more detail herein, a base station 105 or a UE 115 may become unsynchronized, and resynchronization procedures may be adapted based on successful or unsuccessful resynchronization attempts at one or more resynchronization boundaries.

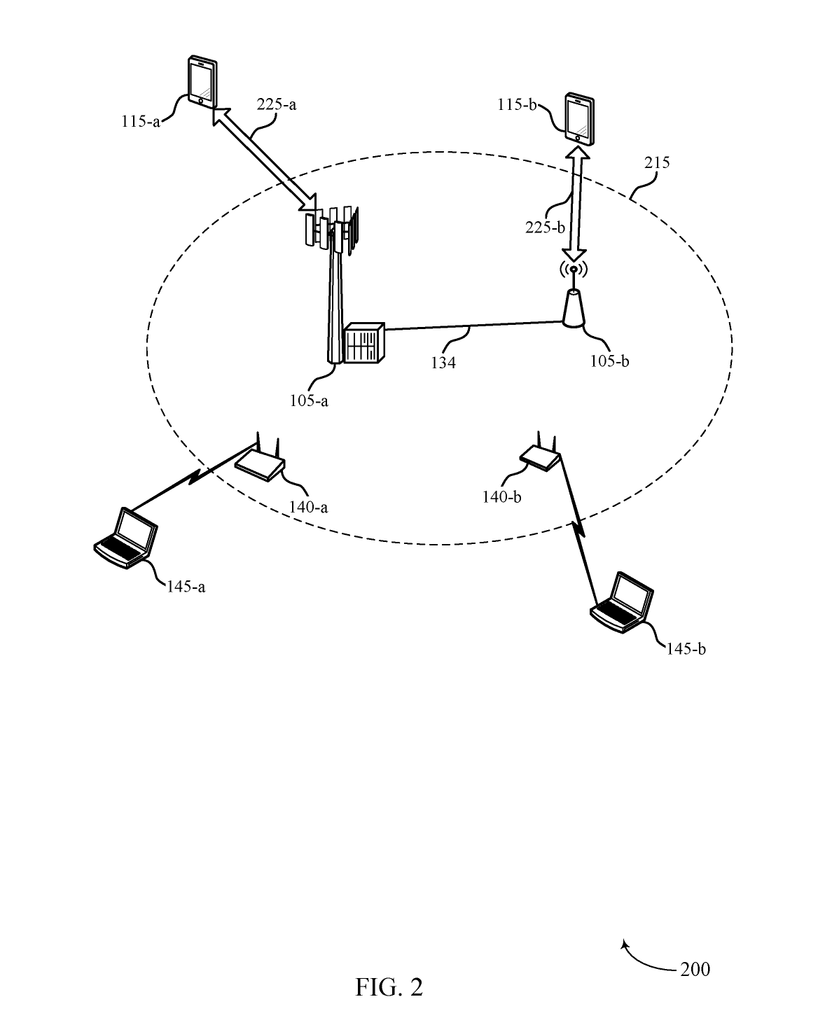

FIG. 2 illustrates an example of a wireless communications system 200 for synchronization across transmitting nodes using shared radio frequency spectrum. Wireless communications system 200 may include a first base station 105-a, second base station 105-b, first UE 115-a, and second UE 115-b, which may be examples of the corresponding devices described with reference to FIG. 1. Base stations 105 and UEs 115 may all be wireless nodes of a first operator (e.g., a first PLMN operator), and in some examples may be referred to as eCC or LAA nodes. In some examples, one or more wireless nodes of a second operator may be present within or adjacent to a coverage area 215 of base stations 105. In the example of FIG. 2, a first Wi-Fi node 140-a and second Wi-Fi node 140-b may be within coverage area 215, and may transmit or receive wireless transmissions to receiving Wi-Fi node 145-a and 145-b, respectively.

In some examples of the wireless communication system 200, the first base station 105-a and first UE 115-a may communicate using a first communications link 225-a, which may provide for both UL and DL communications. Similarly, the second base station 105-b and second UE 115-b may communicate using second communications link 225-b. The base stations 105 also may be connected through backhaul link 134-a, which may be an example of backhaul link 134 of FIG. 1. The communications links 225, in some examples, may transmit waveforms between the base stations 105 and the respective UEs 115 using one or more component carriers that may include OFDMA waveforms, single carrier frequency division multiple access (SC-FDMA) waveforms, or resource block interleaved FDMA waveforms, for example. The communications links 225 may be associated with a frequency in the shared radio frequency spectrum band. This example is presented for illustrative purposes and there may be other similar modes of operation or deployment scenarios that provide LTE/LTE-A communication in a shared radio frequency spectrum band. In some examples, base station 105-a may be deployed in a residential, small business, medium business, or enterprise environment, and may allow UEs 115 to establish connections using shared radio frequency spectrum band(s). Such a deployment may allow UEs 115 to operate using shared radio frequency spectrum band and reduce data usage provided through licensed radio frequency spectrum bands, which may help reduce costs for users. In some examples, base stations 105 and UEs 115 may include hardware for both licensed spectrum access as well as shared spectrum access.

As discussed above, when using shared radio frequency spectrum, the base stations 105 and UEs 115 may perform LBT procedures to determine that the shared radio frequency spectrum is available for transmission. As also discussed above, the some existing techniques may provide that the base stations 105 and UEs 115 may concurrently transmit using frequency reuse techniques on synchronized LBT frames. However, in the event that first base station 105-a and second base station 105-b are not synchronized (e.g., if second base station 105-b receives new data for transmission to second UE 115-b or if second base station 105-b failed a prior CCA), the second base station 105-b may need to contend for access to the shared radio frequency spectrum band with each of first base station 105-a, and Wi-Fi nodes 140. Various aspects of the present disclosure provide techniques for the second base station 105-b (or other node such as UEs 115) to adaptively attempt to synchronize or resynchronize with the first base station 105-a at a resynchronization, or superframe, boundary, and allow for frequency reuse.

In some examples, first base station 105-a and second base station 105-b may initially be synchronized, but may become unsynchronized within a particular superframe, between resynchronization boundaries. For example, first base station 105-a may detect that first Wi-Fi node 140-a is transmitting during an LBT procedure that is performed between resynchronization boundaries. The first base station 105-a may attempt to resynchronize by performing a resynchronization procedure at a subsequent resynchronization boundary. If the resynchronization is successful, the first base station 105-a is again synchronized with the other nodes, and reuse one mode operation may be continued. If the resynchronization is unsuccessful, the first base station 105-a then may contend for channel access and continue to operate in an unsynchronized manner until a subsequent resynchronization boundary. As indicated above, in such cases, the first base station 105-a may have relinquished the shared radio frequency spectrum band earlier than it would have otherwise, which may reduce overall network efficiency.

In some examples, the first base station 105-a, after loss of synchronization and an unsuccessful resynchronization attempt, may modify a parameter of the resynchronization procedure. Such a parameter may be a time interval for a next resynchronization attempt, which may be modified to allow the first base station 105-a to skip a subsequent resynchronization procedure at a next resynchronization boundary. In some examples, the parameter may be probability associated with a determination of whether to perform the resynchronization procedure at a next resynchronization boundary or not. Such a probability may be decreased after an initial resynchronization failure, and may be further decreased after additional resynchronization failures. In some examples, the parameter may be reset to an initial value, such as a probability of 1.0, upon a successful resynchronization. In certain examples, if a node, such as the first base station 105-a, transmits through a resynchronization boundary, an identifier may be included with the transmission to indicate to other nodes, such as the second base station 105-a and the UEs 115, that the first base station 105-a is transmitting through the resynchronization boundary. The first base station 105-a in this example may also indicate an end time of the transmission. Upon detecting the transmission that extends through the resynchronization boundary, the second base station 105-b or UEs 115 may identify that the transmission is from the first base station 105-a, and not make adjustments to resynchronization parameters. In some examples, the second base station 105-b or UEs 115, upon detecting the transmission and identification of the first base station 105-a, may begin synchronized transmissions.

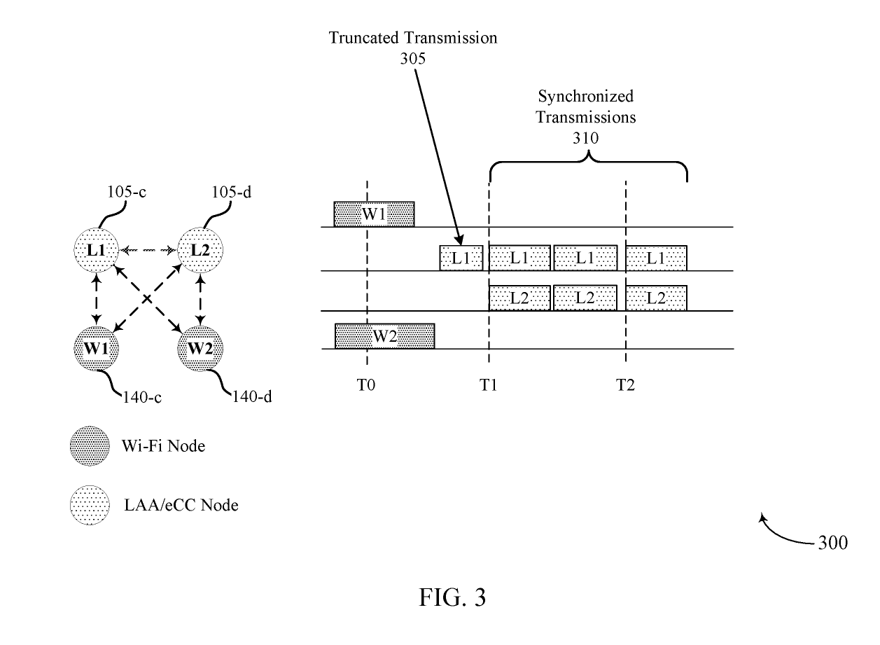

FIG. 3 illustrates an example of wireless transmissions 300 in which a node may resynchronize with another node using shared radio frequency spectrum in accordance with aspects of the present disclosure. In some cases, wireless transmissions 300 may represent aspects of techniques performed by a UE 115 or base station 105 as described with reference to FIGS. 1-2. In the example of FIG. 3, a first base station 105-c and a second base station 105-d, which may be examples of eCC/LAA wireless nodes, may transmit and receive transmissions from one or more UEs (e.g., UEs 115 of FIGS. 1-2) using a shared radio frequency spectrum band. While the example of FIG. 3 illustrates base stations 105 as eCC/LAA wireless nodes, in other examples one or more of the eCC/LAA nodes may be a UE. A first Wi-Fi node 140-c and a second Wi-Fi node 140-d may be in proximity to the base stations 105 such that each of the base stations 105 and Wi-Fi nodes 140 are within a range such that if one is transmitting the remainder will not pass the LBT procedure (e.g., each of the base stations 105 may be within a preamble detection (PD) range of each Wi-Fi node 140), as indicated by the broken lines connecting the devices 105, 140. In this example, the first Wi-Fi node 140-c and the second Wi-Fi node 140-d may not be within PD range of each other, and may transmit simultaneously.

In the example of FIG. 3, the first Wi-Fi node 140-c, and second Wi-Fi node 140-d may each transmit independent transmissions that span an initial resynchronization boundary T0. The base stations 105 may attempt to synchronize at the initial resynchronization boundary T0 by performing an LBT procedure, but detect the transmissions of Wi-Fi nodes 140 and thus not win contention for the channel. Prior to a first resynchronization boundary T1, the first base station 105-c may contend for and win channel contention and initiate a transmission 305. In this example, the first base station 105-c may truncate the transmission in order to perform a resynchronization procedure at the first resynchronization boundary T1. In this case, both the first base station 105-c and the second base station 105-d may have a successful LBT procedure, and the first base station 105-c and the second base station 105-d may transmit synchronized transmissions 310. At a second resynchronization boundary T2, both the first base station 105-c and the second base station 105-d may have a successful LBT procedure, and the first base station 105-c and the second base station 105-d may continue to transmit synchronized transmissions 310.

As indicated above, transmissions between the first base station 105-c and the second base station 105-e may be synchronized to enable frequency reuse during a superframe. In some examples, a synchronization superframe may have a duration MT, where T is the duration of a transmission opportunity (TxOP) for the first base station 105-c and the second base station 105 and M is an integer number that may be configured across each of the synchronized nodes. Within a kth superframe window [kMT, (k+1)MT−Δ), where Δ is a time period for discontinuing transmissions ahead of a resynchronization boundary at the end of the superframe, an LBT procedure can be performed independently by each node. In the example of FIG. 3, truncated transmission 305 may be initiated by the first base station 105-c and truncated so as to not cross retransmission boundary T1, and thus the truncated transmission 305 ends by kMT−Δ.

As part of the resynchronization procedure, at each resynchronization boundary, CCA counters of all nodes of an operator may be synchronized such that a same random number N in [1,q] is generated by all nodes, and the CCA procedure for each of the nodes will have a same duration. The value of M may be selected to provide a small enough value to allow for resynchronization relatively periodically, but large enough to allow for relatively infrequent truncations transmissions which can negatively impact data throughput for a node that is in the presence of relatively active Wi-Fi nodes. As indicated above, various aspects of the present disclosure provide that a node may modify a resynchronization parameter based on successful or unsuccessful resynchronization attempts. Such modifications may allow the node to transmit through a resynchronization boundary in some cases.

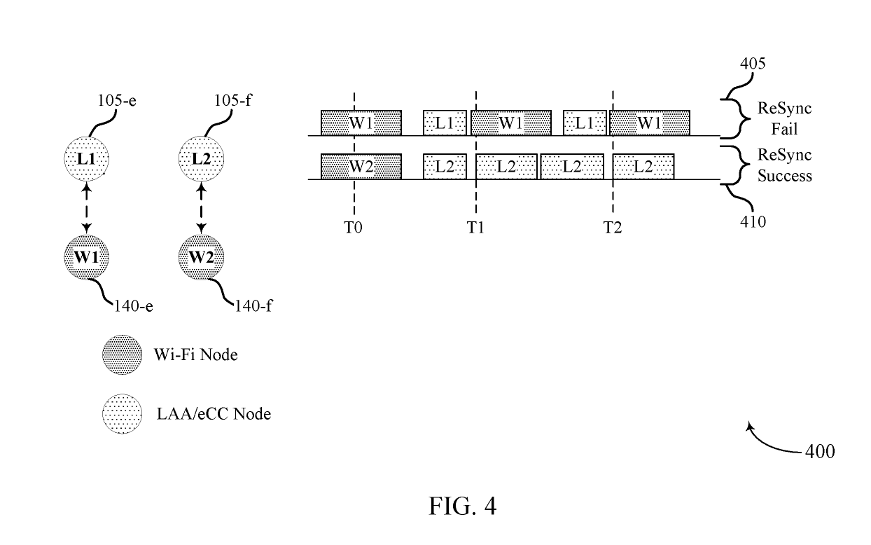

FIG. 4 illustrates wireless transmissions 400 having successful and unsuccessful resynchronization procedures using shared radio frequency spectrum in accordance with aspects of the present disclosure. In some cases, wireless transmissions 400 may represent aspects of techniques performed by a UE 115 or base station 105 as described with reference to FIGS. 1-2. In the example of FIG. 4, a first base station 105-e and a second base station 105-f, which may be examples of eCC/LAA wireless nodes, may transmit and receive transmissions from one or more UEs (e.g., UEs 115 of FIGS. 1-2) using a shared radio frequency spectrum band. While the example of FIG. 4 illustrates base stations 105 as eCC/LAA wireless nodes, in other examples one or more of the eCC/LAA nodes may be a UE. A first Wi-Fi node 140-e may be in PD range of the first base station 105-e, as indicated by the broken line connecting first Wi-Fi node 140-e and first base station 105-e. Similarly, a second Wi-Fi node 140-f may be in PD range of the second base station 105-f, as indicated by the broken line connecting first Wi-Fi node 140-f and first base station 105-f. The first Wi-Fi node 140-e may be outside of the PD range of second base station 105-f and second Wi-Fi node 140-f, and the second Wi-Fi node 140-f may be outside of the PD range of first base station 105-e and first Wi-Fi node 140-e.

In this example, the first Wi-Fi node 140-e may be relatively active, while the second Wi-Fi node 140-f may be relatively inactive. In this example, the base stations 105 may attempt to synchronize at the initial resynchronization boundary T0 by performing an LBT procedure, but detect the transmissions of Wi-Fi nodes 140 and thus not win contention for the channel. Prior to a first resynchronization boundary T1, each of the first base station 105-e and second base station 105-f may contend for and win channel contention and initiate transmissions. In this example, each base station may truncate its transmission in order to perform a resynchronization procedure at the first resynchronization boundary T1.

In this case, the first Wi-Fi node 140-e may initiate transmissions that prevent the first base station 105-e from gaining channel access at subsequent resynchronization boundaries T1 and T2 resulting in resynchronization failures 405 at each resynchronization boundary. The second Wi-Fi node 140-e, however, may transmit less frequently which may allow the second base station 105-e to retain channel access at subsequent resynchronization boundaries T1 and T2. Thus, the throughput of the first base station 105-e may be substantially impacted, while the second base station 105-f may successfully resynchronize, which may allow one or more other nodes of the operator outside of PD range of first Wi-Fi node 140-e to synchronize and utilize frequency reuse.

In some examples, the first base station 105-e, following one or more resynchronization failures, may adapt a resynchronization parameter that may allow transmissions to span a resynchronization boundary. In some examples, the first base station 105-e may attempt a resynchronization procedure with a probability p_{sync}, which may be adapted to decrease on a resynchronization failure and to increase on resynchronization success. The base station 105-e may, for example, select a random number between zero and one, and attempt a resynchronization in the event that the random number is less than p_{sync}. Thus, after multiple resynchronization failures, the value of p_{sync} may be relatively low making it more likely that the first base station 105-e will not determine to attempt resynchronization and potentially transmit across a resynchronization. In some examples, the values of p_{sync} may decrease and increase by a set value between an allowed minimum value and 1.0. In other examples, p_{sync} may be adapted based on an exponential rule where p_{sync} is initialized to 1.0, reduced by 50% on each resynchronization failure (e.g., p_{sync}=p_{sync}/2 after each failure down to an allowed minimum value), and upon resynchronization success may be reset back to the initial value. It is to be understood that the above examples are merely two examples and that numerous other rules for adaptation of a resynchronization may be implemented.

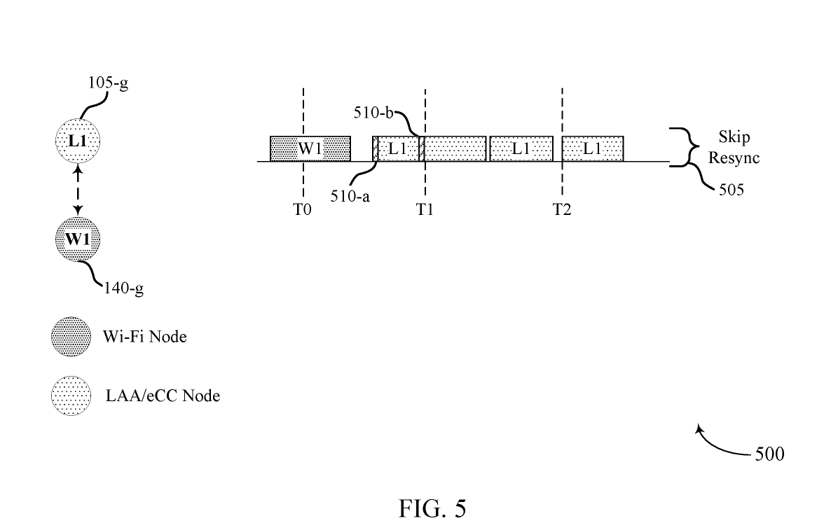

FIG. 5 illustrates an example of a wireless transmission 500 that transmits through a resynchronization boundary in accordance with aspects of the present disclosure. In some cases, wireless transmission 500 may represent aspects of techniques performed by a UE 115 or base station 105 as described with reference to FIGS. 1-2. In the example of FIG. 5, a first base station 105-g, which may be an example of an eCC/LAA wireless nodes, may transmit and receive transmissions from one or more UEs (e.g., UEs 115 of FIGS. 1-2) using a shared radio frequency spectrum band. While the example of FIG. 5 illustrates base station 105-g as an eCC/LAA wireless nodes, in other examples the eCC/LAA node may be a UE. A Wi-Fi node 140-g may be in PD range of the base station 105-g, as indicated by the broken line connecting Wi-Fi node 140-g and base station 105-g.

In this example, the base station 105-g may transmit transmissions 505 that may span through a resynchronization boundary T1, in a manner similarly as discussed above. For example, the base station 105-g may have had one or more prior unsuccessful resynchronization attempts may have adapted a resynchronization parameter that allowed the base station 105-g to transmit through resynchronization boundary T1. In some examples, the base station 105-g (or other node that skips a resynchronization procedure) may transmit an indicator 510 that may identify the transmission as a spanning the resynchronization boundary T1.

In some examples, such a transmission may be provided in indicator 510-a at the beginning of the transmission that will span the resynchronization boundary T1. In other examples, indicator 510-b may be transmitted during the time period that other nodes may perform a resynchronization procedure. A node of a set of synchronized nodes that receives the indicator 510 may identify the transmission as from another node of the set of synchronized nodes. In some examples, the indicator 510 may include one or more of an identifier or a stop time of the wireless transmission that spans the resynchronization boundary T1. Another node that receives the indicator 510 may fail its LBT procedure, and may not adapt its resynchronization parameter (e.g., a value of p_{sync} may be maintained). In other examples, another nodes that receives indicator 510 may begin synchronized transmission as though its LBT procedure had been successful. In some examples, the other node may use information on the end of the base station 105-g transmission to determine a duration of the synchronized transmissions. In some examples, nodes of a set of synchronized nodes may also monitor the shared radio frequency spectrum for presence of Wi-Fi beacon signals that do not have accompanying data, and do not modify the resynchronization parameter if only a Wi-Fi beacon signal is detected.

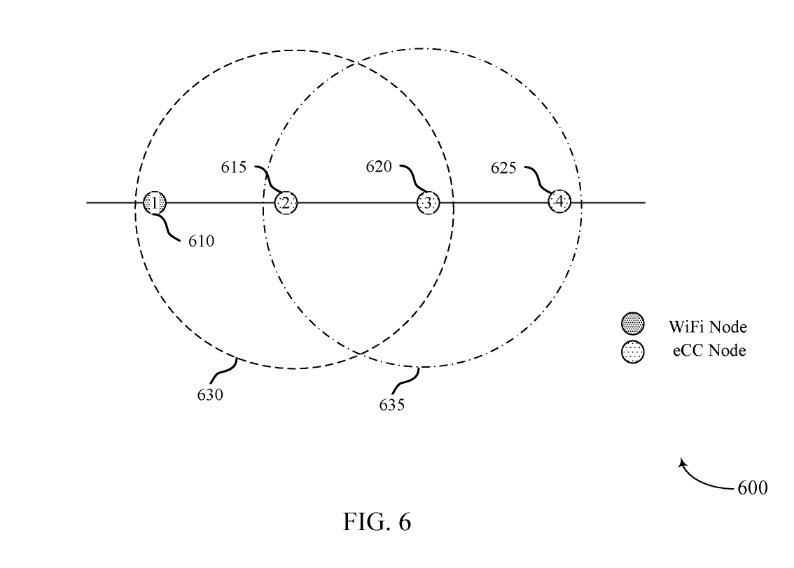

FIG. 6 illustrates an example system 600 of wireless nodes operating using different wireless channels when within energy detection range of a different wireless node in accordance with aspects of the present disclosure. In some cases, system 600 may represent aspects of techniques performed by a UE 115 or base station 105 as described with reference to FIGS. 1-2. In the example of FIG. 6, a Wi-Fi node 610 may be within a PD range 630 of a first node 615 of a set of synchronized nodes but outside of a PD range 635 of a second node 620 and a third node 625 of the set of synchronized nodes. If two or more wireless channels are available (e.g., channels f1 and f2 within a shared radio frequency spectrum), and the Wi-Fi node 610 is transmitting only on a first wireless channel (e.g., f1), the first node 615 (and any other node that is within PD range of the Wi-Fi node 610) may move to a second channel (e.g., f2) for transmissions. In some examples, the first node 615 may semi-statically move to the second channel. Other of the nodes of the set of synchronized nodes, namely second node 620 and third node 625 in the example of FIG. 6, that are away from the Wi-Fi node 610 may remain on the first channel and continue to use synchronized LBT procedures to allow for frequency reuse, and may also transmit on the second channel with synchronized LBT procedures.

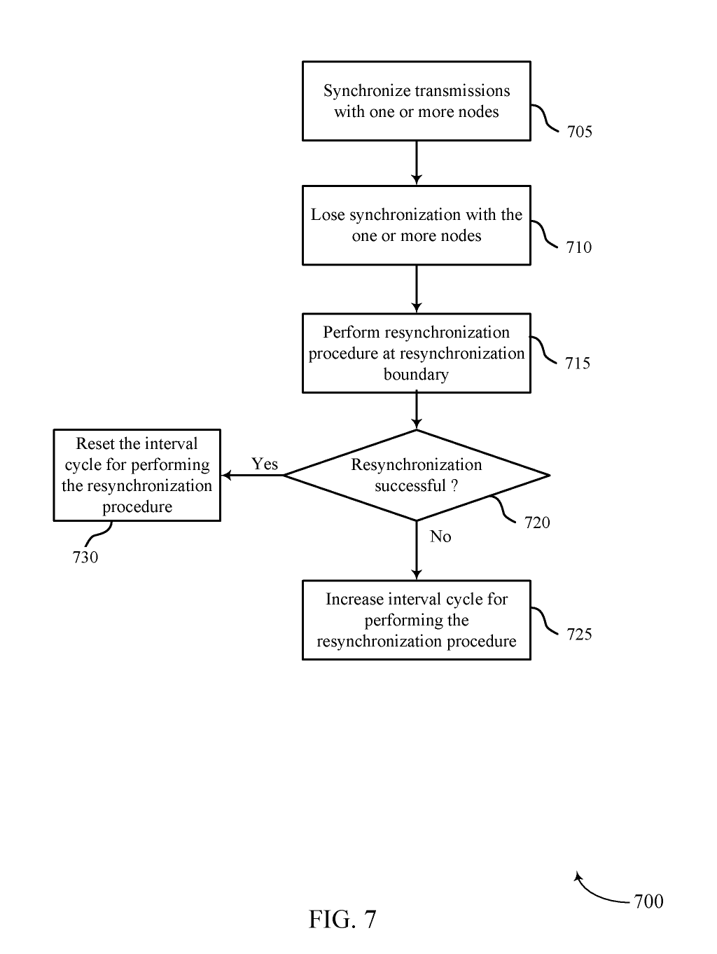

FIG. 7 illustrates an example of a process flow 700 in a system that supports synchronization across transmitting nodes using shared radio frequency spectrum in accordance with aspects of the present disclosure. In some cases, process flow 700 may represent aspects of techniques performed by a UE 115 or base station 105 as described with reference to FIGS. 1-2.

In the example of FIG. 7, a wireless node (e.g., a UE 115 or base station 105 of FIGS. 1-5, or wireless node 615-625 of FIG. 6), may synchronize transmissions with one or more other nodes, as indicated at block 705. In some examples, the wireless node may synchronize transmissions through synchronized LBT procedures performed at resynchronization boundaries, similarly as discussed above. Such synchronized transmissions may allow for frequency reuse among nodes with synchronized transmissions, and thus may enhance the utilization of a wireless network.

At block 710, the wireless node may lose synchronization with the one or more other nodes. Such a loss of synchronization may be the result of a node of a different RAT, such as a Wi-Fi node, that starts transmitting and causes an LBT failure at the wireless node. The wireless node may, in some examples, perform LBT procedures and initiate unsynchronized transmissions until a subsequent resynchronization boundary.

At block 715, the wireless node may perform a resynchronization procedure at a subsequent resynchronization boundary. The resynchronization procedure, similarly as discussed above, may include resetting CCA counters and performing a CCA to determine if a wireless channel in shared radio frequency spectrum is available for transmission. In some examples, the wireless node may truncate an ongoing transmission to perform the resynchronization procedure.

At block 720, it is determined whether the resynchronization is successful. It may be determined that the resynchronization is successful, for example, if the wireless node gains access to the wireless channel in the shared radio frequency spectrum, such as through a CCA procedure. If the wireless node does not gain access to the wireless channel in the shared radio frequency spectrum, such as due to a failure of the CCA procedure, it may be determined that the resynchronization is not successful.

If the resynchronization is not successful, the wireless node, at block 725, may increase an interval cycle for performing the resynchronization procedure. The increase in the interval cycle may allow the wireless node, in some examples, to skip a subsequent resynchronization procedure and transmit a transmission through a subsequent resynchronization boundary. In some examples, the increase in the interval cycle may be obtained through a decrease in a probability that the resynchronization procedure will be performed at a subsequent resynchronization boundary.

If the resynchronization is determined to be successful at block 720, the wireless node, at block 730, may reset the interval cycle for performing the resynchronization procedure. In some examples, resetting the interval cycle for performing the resynchronization procedure may include setting a probability for performing the resynchronization procedure to an initial value (e.g., a probability of 1.0) for a subsequent resynchronization boundary. Thus, resynchronization procedures may be adaptively performed based on one or more prior successful or unsuccessful resynchronization procedures.

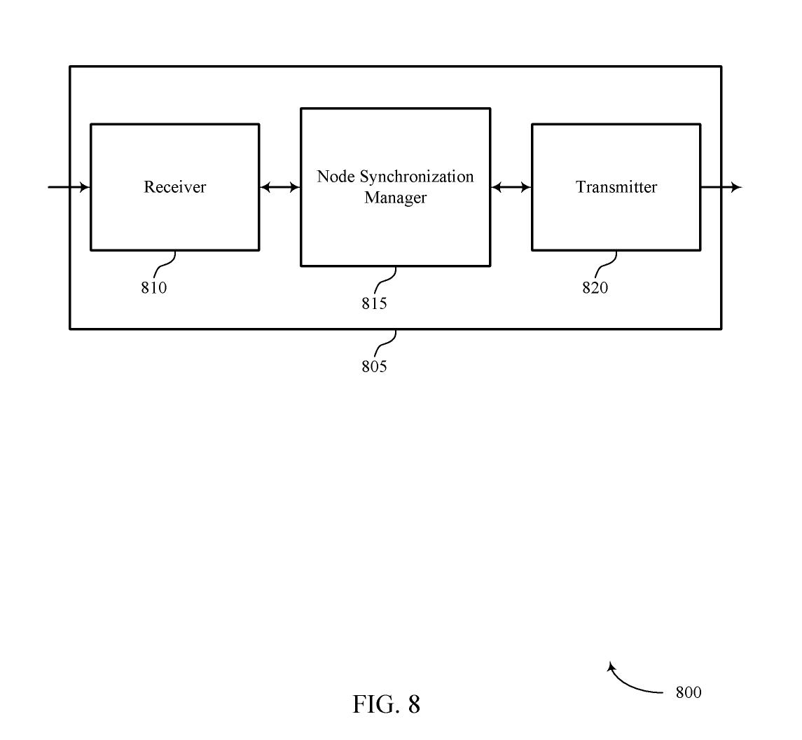

FIG. 8 shows a block diagram 800 of a device 805 that supports synchronization for multiple nodes in accordance with various aspects of the present disclosure. Device 805 may be an example of aspects of a UE 115 or base station 105 as described with reference to FIGS. 1 and 2. Wireless device 805 may include receiver 810, node synchronization manager 815, and transmitter 820. Device 805 may also include a processor. Each of these components may be in communication with one another (e.g., via one or more buses).

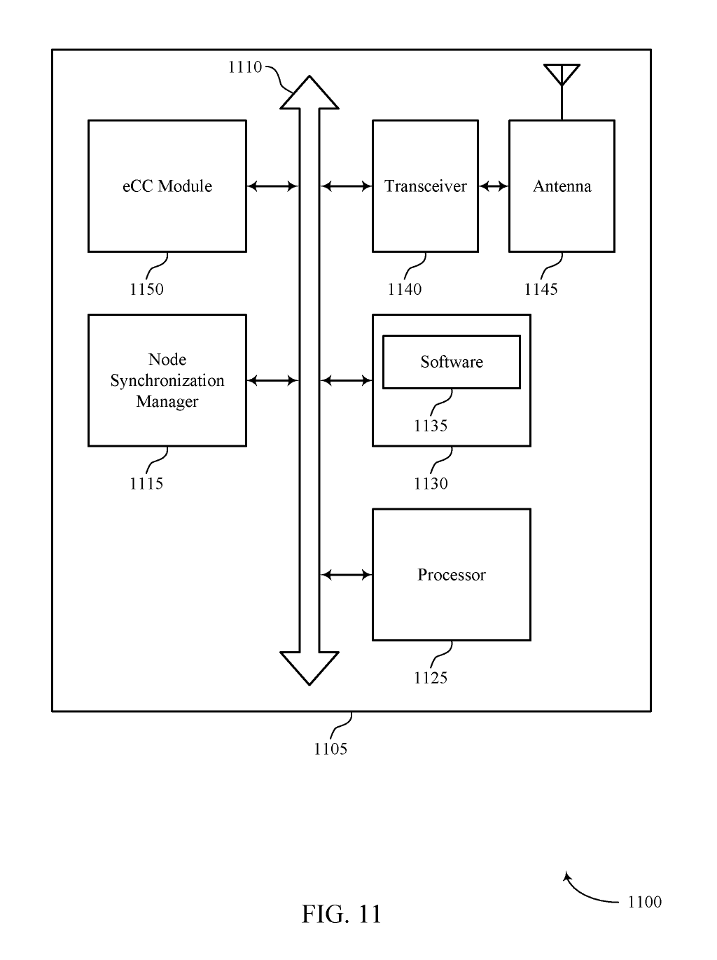

The receiver 810 may receive information such as packets, user data, or control information associated with various information channels (e.g., control channels, data channels, and information related to synchronization for multiple nodes, etc.). Information may be passed on to other components of the device. The receiver 810 may be an example of aspects of the transceiver 1140 described with reference to FIG. 11.

The node synchronization manager 815 may be an example of aspects of the node synchronization manager 1115 described with reference to FIG. 11.

The node synchronization manager 815 may synchronize transmissions with one or more wireless nodes, identify a loss of synchronization with the one or more wireless nodes, perform a resynchronization procedure at a first resynchronization boundary to attempt to resynchronize with the one or more wireless nodes, and adapt a parameter associated with the resynchronization procedure based on an outcome of the resynchronization procedure at the first resynchronization boundary.

The transmitter 820 may transmit signals generated by other components of the device. In some examples, the transmitter 820 may be collocated with a receiver 805 in a transceiver module. For example, the transmitter 820 may be an example of aspects of the transceiver 1140 described with reference to FIG. 11. The transmitter 820 may include a single antenna, or it may include a set of antennas.

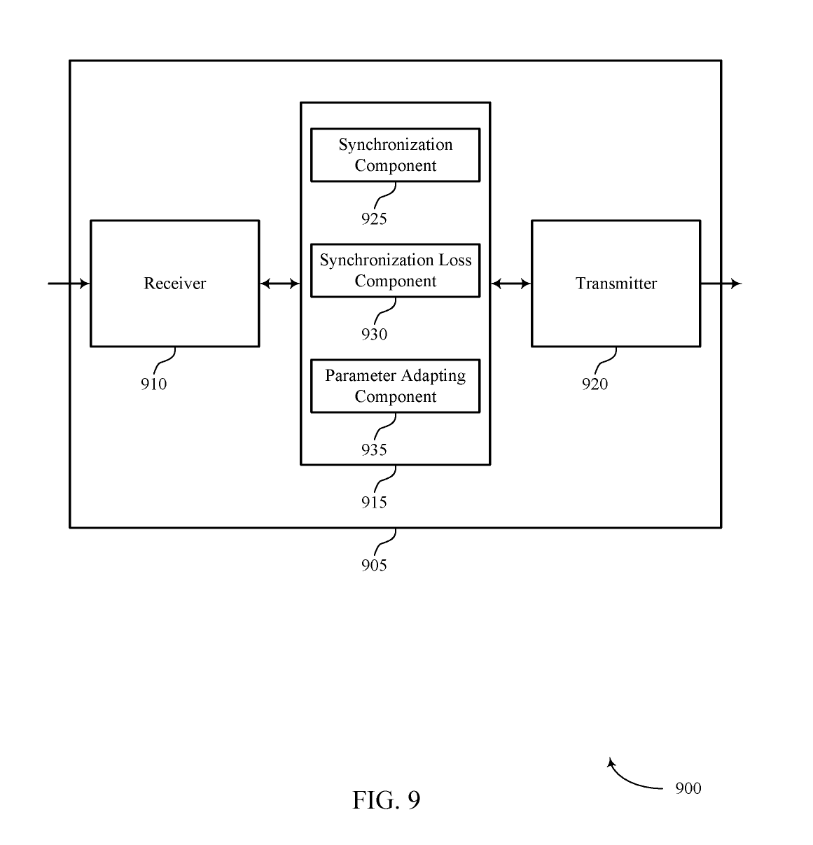

FIG. 9 shows a block diagram 900 of a device 905 that supports synchronization for multiple nodes in accordance with various aspects of the present disclosure. Device 905 may be an example of aspects of a device 805 or a UE 115 or base station 105 as described with reference to FIGS. 1, 2 and 8. Wireless device 905 may include receiver 910, node synchronization manager 915, and transmitter 920. Device 905 may also include a processor. Each of these components may be in communication with one another (e.g., via one or more buses).

The receiver 910 may receive information such as packets, user data, or control information associated with various information channels (e.g., control channels, data channels, and information related to synchronization for multiple nodes, etc.). Information may be passed on to other components of the device 905. The receiver 910 may be an example of aspects of the transceiver 1140 described with reference to FIG. 11.

The node synchronization manager 915 may be an example of aspects of the node synchronization manager 1115 described with reference to FIG. 11. The node synchronization manager 915 may also include synchronization component 925, synchronization loss component 930, and parameter adapting component 935.

The synchronization component 925 may synchronize transmissions with one or more wireless nodes, perform a resynchronization procedure at a first resynchronization boundary to attempt to resynchronize with the one or more wireless nodes. In some examples, the synchronization component 925 may determine to perform the resynchronization procedure at a second resynchronization boundary based on a parameter associated with the resynchronization procedure. In some cases, the one or more wireless nodes are associated with a group of wireless nodes, and the synchronization component 925 may determine that a second wireless node outside of the group of wireless nodes is operating using a first wireless channel.

The synchronization loss component 930 may identify a loss of synchronization with the one or more wireless nodes.

The parameter adapting component 935 may adapt a parameter associated with the resynchronization procedure based on an outcome of the resynchronization procedure at the first resynchronization boundary. In some cases, parameter adapting component 935 may maintain the parameter associated with the resynchronization procedure based on the identification of the wireless transmission of one of the one or more wireless nodes, maintain the parameter associated with the resynchronization procedure based on the identification of the beacon signal, or any combination thereof.

The transmitter 920 may transmit signals generated by other components of the device 905. In some examples, the transmitter 920 may be collocated with a receiver 905 in a transceiver module. For example, the transmitter 920 may be an example of aspects of the transceiver 1140 described with reference to FIG. 11. The transmitter 920 may include a single antenna, or it may include a set of antennas.

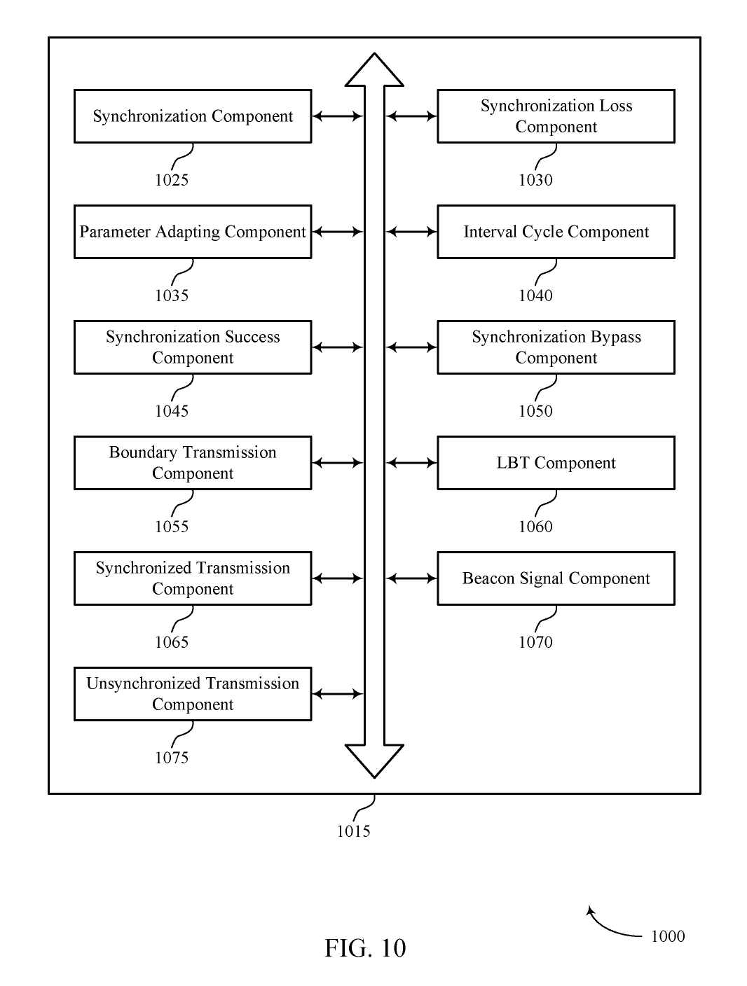

FIG. 10 shows a block diagram 1000 of a node synchronization manager 1015 that supports synchronization for multiple nodes in accordance with various aspects of the present disclosure. The node synchronization manager 1015 may be an example of aspects of a node synchronization manager 815, a node synchronization manager 915, or a node synchronization manager 1115 described with reference to FIGS. 8, 9, and 11. The node synchronization manager 1015 may include synchronization component 1025, synchronization loss component 1030, and parameter adapting component 1035. Each of these modules may communicate, directly or indirectly, with one another (e.g., via one or more buses).

The synchronization component 1025 may synchronize transmissions with one or more wireless nodes, and perform a resynchronization procedure at a first resynchronization boundary to attempt to resynchronize with the one or more wireless nodes. In some examples, the synchronization component 1025 may determine to perform the resynchronization procedure at a second resynchronization boundary based on the parameter associated with the resynchronization procedure. In some cases, the one or more wireless nodes are associated with a group of wireless nodes, and the synchronization component 1025 may determine that a second wireless node outside of the group of wireless nodes is operating using a first wireless channel.

The synchronization loss component 1030 may identify a loss of synchronization with the one or more wireless nodes.

The parameter adapting component 1035 may adapt a parameter associated with the resynchronization procedure based on an outcome of the resynchronization procedure at the first resynchronization boundary. In some cases, the parameter adapting component 1035 may maintain the parameter associated with the resynchronization procedure based on the identification of the wireless transmission of one of the one or more wireless nodes, maintain the parameter associated with the resynchronization procedure based on the identification of the beacon signal, or any combination thereof.

The interval cycle component 1040 may modify an interval cycle for performing the resynchronization procedure. In some cases, modifying the interval cycle for performing the resynchronization procedure includes increasing a probability that the resynchronization procedure will be performed at a second resynchronization boundary. In some cases, modifying the interval cycle for performing the resynchronization procedure includes reducing a probability that the resynchronization procedure will be performed at a second resynchronization boundary.

The synchronization success component 1045 may determine that the resynchronization procedure at the first resynchronization boundary was either successful or unsuccessful. In some cases, the adapting the parameter associated with the resynchronization procedure may be based on the synchronization success component 1045 determining that the resynchronization procedure at the first resynchronization boundary was successful. In some cases, the adapting of the parameter associated with the resynchronization procedure may further be based on the synchronization success component 1045 determining that the resynchronization procedure at the first resynchronization boundary was unsuccessful. In some cases, the adapting the parameter associated with the resynchronization procedure may further be based on the synchronization success component 1045 determining that the resynchronization procedure at a predetermined number of resynchronization boundaries was unsuccessful.

The synchronization bypass component 1050 may determine to perform or to skip the resynchronization procedure at a second resynchronization boundary based as least in part on interval cycle for performing the resynchronization procedure, the parameter associated with the resynchronization procedure, or any combination thereof.

The boundary transmission component 1055 may cause transmission of a wireless transmission that spans through the second resynchronization boundary. In some cases, the boundary transmission component 1055 may identify, during an LBT procedure, a wireless transmission of one of the one or more wireless nodes that spans the second resynchronization boundary. In some cases, transmitting the wireless transmission includes one or more of an identifier or a stop time of the wireless transmission.

The LBT component 1060 may perform an LBT procedure as part of the resynchronization procedure at the second resynchronization boundary and perform an LBT procedure as part of one or more unsynchronized transmissions.

The synchronized transmission component 1065 may initiate a synchronized wireless transmission at the second resynchronization boundary based on the identification of the wireless transmission of one of the one or more wireless nodes.

The beacon signal component 1070 may identify, during the LBT procedure, a beacon signal from a different wireless node operating using a different RAT.

The unsynchronized transmission component 1075 may manage transmission of wireless transmissions that are unsynchronized with other wireless nodes of a group of wireless nodes using a second wireless channel and other wireless nodes of the group of wireless nodes that are outside of an energy detection range of the second wireless node may transmit synchronized wireless transmissions using the first wireless channel.

FIG. 11 shows a diagram of a system 1100 including a device 1105 that supports synchronization for multiple nodes in accordance with various aspects of the present disclosure. Device 1105 may be an example of a device 800, device 900, or a UE 115 or base station 105 as described above, (e.g., with reference to FIGS. 1, 2, 8 and 9).

Device 1105 may include components for bi-directional voice and data communications including components for transmitting and receiving communications, including node synchronization manager 1115, processor 1125, memory 1130, software 1135, transceiver 1140, antenna 1145, and eCC module 1150.

The processor 1125 may include an intelligent hardware device, (e.g., a central processing unit (CPU), a microcontroller, an application specific integrated circuit (ASIC), etc.).

The memory 1130 may include random access memory (RAM) and read only memory (ROM). The memory 1130 may store computer-readable, computer-executable software 1135 including instructions that, when executed, cause the processor to perform various functions described herein. In some cases, the memory 1130 can contain, among other things, a Basic Input-Output system (BIOS) which may control basic hardware and/or software operation such as the interaction with peripheral components or devices.

Software 1135 may include code to implement aspects of the present disclosure, including code to support synchronization and resynchronization for multiple nodes. Software 1135 can be stored in a non-transitory computer-readable medium such as system memory or other memory. In some cases, the software 1135 may not be directly executable by the processor but may cause a computer (e.g., when compiled and executed) to perform functions described herein.

The transceiver 1140 may communicate bi-directionally, via one or more antennas, wired, or wireless links as described above. For example, the transceiver 1140 may represent a wireless transceiver and may communicate bi-directionally with another wireless transceiver. The transceiver 1140 may also include a modem to modulate the packets and provide the modulated packets to the antennas for transmission, and to demodulate packets received from the antennas.

In some cases, the wireless device may include a single antenna 1145. However, in some cases the device may have more than one antenna 1145, which may be capable of concurrently transmitting or receiving multiple wireless transmissions.

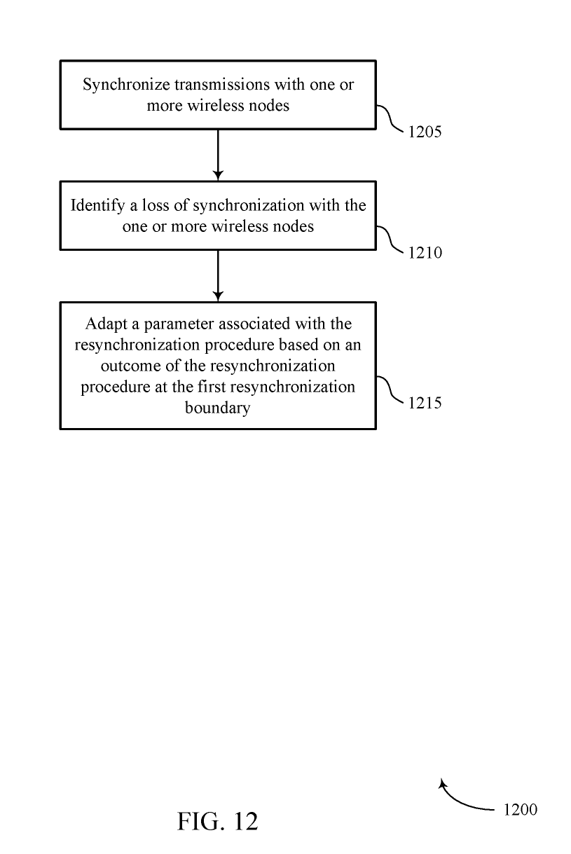

FIG. 12 shows a flowchart illustrating a method 1200 for synchronization for multiple nodes in accordance with various aspects of the present disclosure. The operations of method 1200 may be implemented by a UE 115 or base station 105 or its components as described herein. For example, the operations of method 1200 may be performed by a node synchronization manager as described with reference to FIGS. 8 through 10. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 1205, the UE 115 or base station 105 may synchronize transmissions with one or more wireless nodes. The operations of block 1205 may be performed according to the methods described with reference to FIGS. 2 through 7. In certain examples, the operations of block 1205 may be performed by a synchronization component as described with reference to FIGS. 8 through 10.

At block 1210, the UE 115 or base station 105 may identify a loss of synchronization with the one or more wireless nodes. The operations of block 1210 may be performed according to the methods described with reference to FIGS. 2 through 7. In certain examples, the operations of block 1210 may be performed by a synchronization loss component as described with reference to FIGS. 8 through 10.

At block 1215, the UE 115 or base station 105 may adapt a parameter associated with the resynchronization procedure based on an outcome of the resynchronization procedure at the first resynchronization boundary. The operations of block 1215 may be performed according to the methods described with reference to FIGS. 2 through 7. In certain examples, the operations of block 1215 may be performed by a parameter adapting component as described with reference to FIGS. 8 through 10.

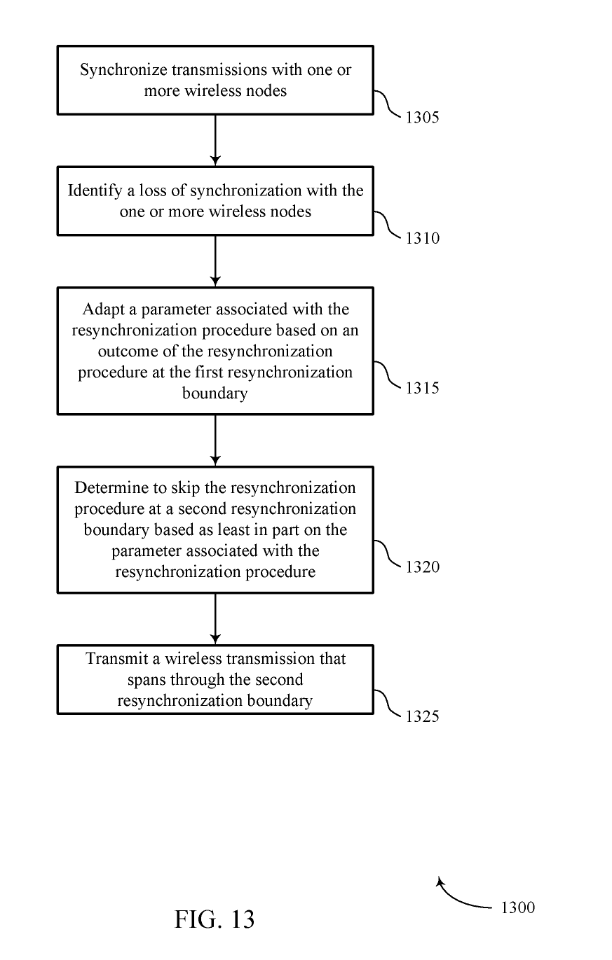

FIG. 13 shows a flowchart illustrating a method 1300 for synchronization for multiple nodes in accordance with various aspects of the present disclosure. The operations of method 1300 may be implemented by a UE 115 or base station 105 or its components as described herein. For example, the operations of method 1300 may be performed by a node synchronization manager as described with reference to FIGS. 8 through 10. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 1305, the UE 115 or base station 105 may synchronize transmissions with one or more wireless nodes. The operations of block 1305 may be performed according to the methods described with reference to FIGS. 2 through 7. In certain examples, the operations of block 1305 may be performed by a synchronization component as described with reference to FIGS. 8 through 10.

At block 1310, the UE 115 or base station 105 may identify a loss of synchronization with the one or more wireless nodes. The operations of block 1310 may be performed according to the methods described with reference to FIGS. 2 through 7. In certain examples, the operations of block 1310 may be performed by a synchronization loss component as described with reference to FIGS. 8 through 10.

At block 1315, the UE 115 or base station 105 may adapt a parameter associated with the resynchronization procedure based on an outcome of the resynchronization procedure at the first resynchronization boundary. The operations of block 1315 may be performed according to the methods described with reference to FIGS. 2 through 7. In certain examples, the operations of block 1315 may be performed by a parameter adapting component as described with reference to FIGS. 8 through 10.

At block 1320, the UE 115 or base station 105 may determine to skip the resynchronization procedure at a second resynchronization boundary based as least in part on the parameter associated with the resynchronization procedure. The operations of block 1320 may be performed according to the methods described with reference to FIGS. 2 through 7. In certain examples, the operations of block 1320 may be performed by a synchronization bypass component as described with reference to FIGS. 8 through 10.

At block 1325, the UE 115 or base station 105 may transmit a wireless transmission that spans through the second resynchronization boundary. The operations of block 1325 may be performed according to the methods described with reference to FIGS. 2 through 7. In certain examples, the operations of block 1325 may be performed by a boundary transmission component as described with reference to FIGS. 8 through 10.

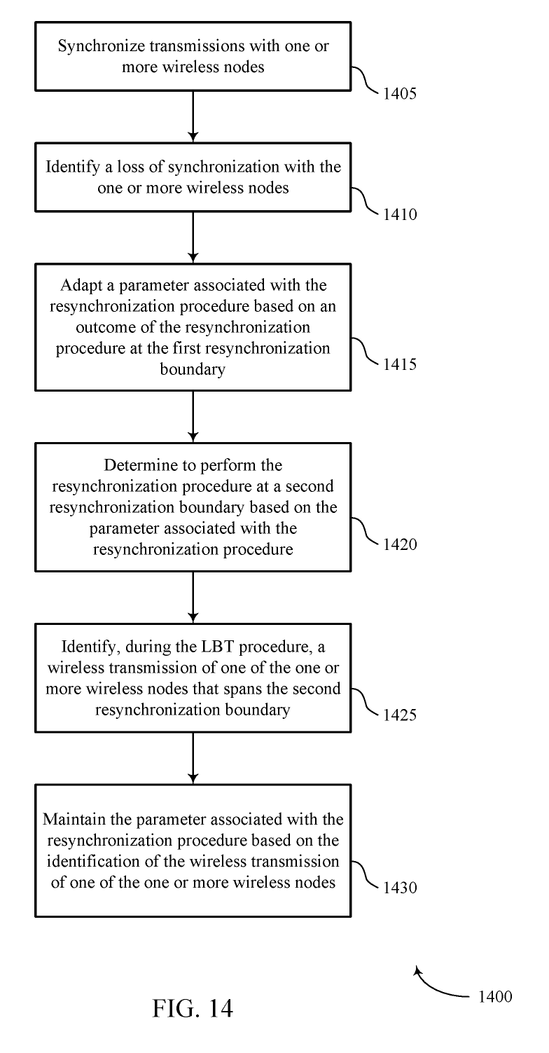

FIG. 14 shows a flowchart illustrating a method 1400 for synchronization for multiple nodes in accordance with various aspects of the present disclosure. The operations of method 1400 may be implemented by a UE 115 or base station 105 or its components as described herein. For example, the operations of method 1400 may be performed by a node synchronization manager as described with reference to FIGS. 8 through 10. In some examples, a UE 115 or base station 105 may execute a set of codes to control the functional elements of the device to perform the functions described below. Additionally or alternatively, the UE 115 or base station 105 may perform aspects of the functions described below using special-purpose hardware.

At block 1405, the UE 115 or base station 105 may synchronize transmissions with one or more wireless nodes. The operations of block 1405 may be performed according to the methods described with reference to FIGS. 2 through 7. In certain examples, the operations of block 1405 may be performed by a synchronization component as described with reference to FIGS. 8 through 10.

At block 1410, the UE 115 or base station 105 may identify a loss of synchronization with the one or more wireless nodes. The operations of block 1410 may be performed according to the methods described with reference to FIGS. 2 through 7. In certain examples, the operations of block 1410 may be performed by a synchronization loss component as described with reference to FIGS. 8 through 10.

At block 1415, the UE 115 or base station 105 may adapt a parameter associated with the resynchronization procedure based on an outcome of the resynchronization procedure at the first resynchronization boundary. The operations of block 1415 may be performed according to the methods described with reference to FIGS. 2 through 7. In certain examples, the operations of block 1415 may be performed by a parameter adapting component as described with reference to FIGS. 8 through 10.

At block 1420, the UE 115 or base station 105 may determine to perform the resynchronization procedure at a second resynchronization boundary based on the parameter associated with the resynchronization procedure. The operations of block 1420 may be performed according to the methods described with reference to FIGS. 2 through 7. In certain examples, the operations of block 1420 may be performed by a synchronization component as described with reference to FIGS. 8 through 10.

At block 1425, the UE 115 or base station 105 may identify, during the LBT procedure, a wireless transmission of one of the one or more wireless nodes that spans the second resynchronization boundary. The operations of block 1425 may be performed according to the methods described with reference to FIGS. 2 through 7. In certain examples, the operations of block 1425 may be performed by a boundary transmission component as described with reference to FIGS. 8 through 10.

At block 1430, the UE 115 or base station 105 may maintain the parameter associated with the resynchronization procedure based on the identification of the wireless transmission of one of the one or more wireless nodes. The operations of block 1430 may be performed according to the methods described with reference to FIGS. 2 through 7. In certain examples, the operations of block 1430 may be performed by a parameter adapting component as described with reference to FIGS. 8 through 10.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications System (UMTS). 3GPP LTE and LTE-Aare new releases of UMTS that use E-UTRA. UTRA, E-UTRA, UMTS, LTE, LTE-A, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
synchronizing transmissions with one or more wireless nodes;
identifying a loss of synchronization with the one or more wireless nodes;
performing a resynchronization procedure at a first resynchronization boundary to attempt to resynchronize with the one or more wireless nodes; and
adapting a parameter associated with the resynchronization procedure based at least in part on an outcome of the resynchronization procedure at the first resynchronization boundary.

2. The method of claim 1, wherein the adapting the parameter associated with the resynchronization procedure comprises:
modifying an interval cycle for performing the resynchronization procedure.

3. The method of claim 2, wherein the adapting the parameter associated with the resynchronization procedure further comprises:
determining that the resynchronization procedure at the first resynchronization boundary was successful; and
wherein modifying the interval cycle for performing the resynchronization procedure comprises increasing a probability that the resynchronization procedure will be performed at a second resynchronization boundary.

4. The method of claim 2, wherein the adapting the parameter associated with the resynchronization procedure further comprises:
determining that the resynchronization procedure at the first resynchronization boundary was unsuccessful; and
wherein modifying the interval cycle for performing the resynchronization procedure comprises reducing a probability that the resynchronization procedure will be performed at a second resynchronization boundary.

5. The method of claim 4, wherein the adapting the parameter associated with the resynchronization procedure further comprises:
determining that the resynchronization procedure at a predetermined number of resynchronization boundaries was unsuccessful; and
disabling the resynchronization procedure.

6. The method of claim 2, wherein the method further comprises:
determining to perform or to skip the resynchronization procedure at a second resynchronization boundary based as least in part on the interval cycle for performing the resynchronization procedure.

7. The method of claim 1, further comprising:
determining to skip the resynchronization procedure at a second resynchronization boundary based as least in part on the parameter associated with the resynchronization procedure; and
transmitting a wireless transmission that spans through the second resynchronization boundary, wherein the wireless transmission comprises one or more of an identifier or a stop time of the wireless transmission.

8. The method of claim 1, further comprising:
determining to perform the resynchronization procedure at a second resynchronization boundary based at least in part on the parameter associated with the resynchronization procedure;
performing a listen before talk (LBT) procedure as part of the resynchronization procedure at the second resynchronization boundary;
identifying, during the LBT procedure, a wireless transmission of one of the one or more wireless nodes that spans the second resynchronization boundary; and
maintaining the parameter associated with the resynchronization procedure based at least in part on the identification of the wireless transmission of one of the one or more wireless nodes.

9. The method of claim 8, further comprising:
initiating a synchronized wireless transmission at the second resynchronization boundary based at least in part on the identification of the wireless transmission of one of the one or more wireless nodes.

10. The method of claim 1, further comprising:
determining to perform the resynchronization procedure at a second resynchronization boundary based at least in part on the parameter associated with the resynchronization procedure;
performing a listen before talk (LBT) procedure as part of the resynchronization procedure at the second resynchronization boundary;
identifying, during the LBT procedure, a beacon signal from a different wireless node operating using a different radio access technology; and
maintaining the parameter associated with the resynchronization procedure based at least in part on the identification of the beacon signal.

11. The method of claim 1, wherein the one or more wireless nodes are associated with a group of wireless nodes, and wherein the method further comprises:
determining, at a first wireless node of the group of wireless nodes, that a second wireless node outside of the group of wireless nodes is operating using a first wireless channel; and
transmitting, at the first wireless node, wireless transmissions that are unsynchronized with other wireless nodes of the group of wireless nodes using a second wireless channel.

12. The method of claim 11, wherein other wireless nodes of the group of wireless nodes that are outside of an energy detection range of the second wireless node transmit synchronized wireless transmissions using the first wireless channel.

13. An apparatus for wireless communications, comprising:
means for synchronizing transmissions with one or more wireless nodes;
means for identifying a loss of synchronization with the one or more wireless nodes;
means for performing a resynchronization procedure at a first resynchronization boundary to attempt to resynchronize with the one or more wireless nodes; and
means for adapting a parameter associated with the resynchronization procedure based at least in part on an outcome of the resynchronization procedure at the first resynchronization boundary.

14. The apparatus of claim 13, wherein the means for adapting the parameter associated with the resynchronization procedure modifies an interval cycle for performing the resynchronization procedure.

15. The apparatus of claim 14, wherein the means for adapting the parameter associated with the resynchronization procedure determines that the resynchronization procedure at the first resynchronization boundary was successful, and modifies the interval cycle for performing the resynchronization procedure comprises: increasing a probability that the resynchronization procedure will be performed at a second resynchronization boundary.

16. The apparatus of claim 14, wherein the means for adapting the parameter associated with the resynchronization procedure determines that the resynchronization procedure at the first resynchronization boundary was unsuccessful, and modifies the interval cycle for performing the resynchronization procedure by reducing a probability that the resynchronization procedure will be performed at a second resynchronization boundary.

17. An apparatus for wireless communications, in a system comprising:
a processor;
memory in electronic communication with the processor; and
instructions stored in the memory and operable, when executed by the processor, to cause the apparatus to:
synchronize transmissions with one or more wireless nodes;
identify a loss of synchronization with the one or more wireless nodes;
perform a resynchronization procedure at a first resynchronization boundary to attempt to resynchronize with the one or more wireless nodes; and
adapt a parameter associated with the resynchronization procedure based at least in part on an outcome of the resynchronization procedure at the first resynchronization boundary.

18. The apparatus of claim 17, wherein the instructions are further executable by the processor to:
modify an interval cycle for performing the resynchronization procedure.

19. The apparatus of claim 18, wherein the instructions are further executable by the processor to:
determine that the resynchronization procedure at the first resynchronization boundary was successful; and
modify the interval cycle for performing the resynchronization procedure comprises by increasing a probability that the resynchronization procedure will be performed at a second resynchronization boundary.

20. The apparatus of claim 18, wherein the instructions are further executable by the processor to:
determine that the resynchronization procedure at the first resynchronization boundary was unsuccessful; and
modify the interval cycle for performing the resynchronization procedure by reducing a probability that the resynchronization procedure will be performed at a second resynchronization boundary.
